(19) United States
(12) Patent Application Publication
(10) Pub. No.: US 2016/0139702 A1
(43) Pub. Date: May 19, 2016

(54) Auxiliary Sensors for Electronic Devices

(71) Applicant: Apple Inc., Cupertino, CA (US)

(72) Inventors: Jeremy C. Franklin, San Francisco, CA (US); Justin R. Wodrich, Saratoga, CA (US); Stephen R. McClure, San Francisco, CA (US)

(21) Appl. No.: 14/542,333

(22) Filed: Nov. 14, 2014

(51) Int. Cl. G06F 3/044; H04R 3/00; G10K 11/178; G06F 3/041

(52) U.S. Cl. CPC G06F 3/044; G06F 3/0416; H04R 3/005; G10K 11/1784; G06F 2203/04101; G06F 2203/04103; H04R 2499/11; G10K 2210/108

(57) ABSTRACT

An electronic device may include a display having an active area and an inactive area. The display may include a cover layer and an array of pixels that emit light through the cover layer in the active area. An opaque masking layer may be formed on an inner surface of the cover layer in the inactive area. A touch sensor may include touch sensor electrodes under the opaque masking layer in the inactive area to detect touches near electronic components that are mounted in the inactive area. Operation of the electronic components may be controlled based on signals from the touch sensor in the inactive area. The touch sensor may be formed from capacitive touch sensor electrodes. The capacitive touch sensor electrodes may be formed on the same substrate as an adjacent electronic component or may be formed as an extension of an existing touch sensor in the display.

### BACKGROUND

This relates generally to electronic devices and, more particularly, to electronic devices with auxiliary sensors.

Electronic devices often include sensors and other input-output devices around the perimeter of a display. Light-based proximity sensors can be used to detect whether or not an external object is in the vicinity of a device. Ambient light sensors may measure visible light in the surroundings of a device. Using sensors such as these, a portable electronic device can monitor its surroundings and take suitable actions. For example, operation of electrical components in a device such as display components can be controlled based on sensor readings. Other input-output devices such as microphones and speakers may also be formed at the periphery of an electronic device.

The performance of an input-output device may be compromised when the input-output device is covered by an external object. For example, if an ambient light sensor is covered by a user's hand or finger, the display may be dimmed even when the device is in bright ambient lighting conditions. If a microphone or speaker is covered, audio signals passing to or from the device may be obstructed. It can therefore be challenging to maintain optimal performance from input-output devices in handheld electronic devices that are typically held in a user's hands.

It would therefore be desirable to be able to provide improved sensor configurations for electronic devices.

### SUMMARY

An electronic device may include a display and one or more auxiliary sensors mounted around the periphery of the display. The auxiliary sensors may gather information about where a user's hands are holding the electronic device and whether or not an input-output device is obstructed by an external object.

The electronic device may include a display having an active area and an inactive area. The display may include a cover layer and an array of pixels that emit light through the cover layer in the active area. An opaque masking layer may be formed on an inner surface of the cover layer in the inactive area.

Auxiliary sensors may be formed from an already existing touch sensor in the electronic device. For example, the display may include a touch sensor for receiving touch input from a user. The touch sensor may have a first portion with touch sensor electrodes in the active area and a second portion with one or more auxiliary touch sensor electrodes in the inactive area. The second portion of the touch sensor may extend under the opaque masking layer in the inactive area of the display. The auxiliary touch sensor electrodes may detect touches in the inactive area of the display and may determine whether input-output devices in the inactive area are obstructed by a user's hands or fingers.

Auxiliary sensors may be formed from capacitive touch sensor electrodes localized around an electronic component such as an ambient light sensor, speaker, microphone, or camera. Operation of the electronic component may be controlled based on signals from the touch sensor electrodes.

For example, if the touch sensor electrodes detect that an ambient light sensor is obstructed by an external object, the control circuitry may disable the ambient light sensor, may ignore ambient light sensor data that is gathered while the ambient light sensor is obstructed, and/or may use a different ambient light sensor to gather ambient light signals.

If an auxiliary sensor detects that an acoustic port is covered, the electronic device may use an audio device associated with a different acoustic port to transmit or receive audio signals.

Further features of the invention, its nature and various advantages will be more apparent from the accompanying drawings and the following detailed description of the preferred embodiments.

### BRIEF DESCRIPTION OF THE DRAWINGS

FIG. 1 is a front perspective view of an illustrative electronic device of the type that may be provided with sensors in accordance with an embodiment of the present invention.

FIG. 2 is a rear perspective view of an illustrative electronic device of the type that may be provided with sensors in accordance with an embodiment of the present invention.

FIG. 3 is a schematic diagram of an illustrative electronic device with sensor circuitry in accordance with an embodiment of the present invention.

FIG. 4 is a cross-sectional side view of an electronic device showing how sensor structures may be mounted around a periphery of the electronic device in accordance with an embodiment of the present invention.

FIG. 5 is a top view of an illustrative ambient light sensor mounted on a flexible printed circuit and surrounded by touch sensor electrodes in accordance with an embodiment of the present invention.

FIG. 6 is a top view of an illustrative ambient light sensor mounted to a flexible printed circuit and surrounded by a touch sensor electrode in accordance with an embodiment of the present invention.

FIG. 7 is a cross-sectional side view of illustrative microphones mounted to a flexible printed circuit and surrounded by touch sensor electrodes in accordance with an embodiment of the present invention.

FIG. 8 is a top view of illustrative microphones mounted to a flexible printed circuit and surrounded by touch sensor electrodes in accordance with an embodiment of the present invention.

FIG. 9 is a top view of an illustrative touch sensor having a central portion with touch sensor electrodes for receiving touch input in the inactive area of the display and an extended portion with touch sensor electrodes for detecting external objects in the inactive area of the display in accordance with an embodiment of the present invention.

FIG. 10 is a top view of an illustrative touch sensor having a central portion with touch sensor electrodes for receiving touch input in the inactive area of the display and an extended portion with a touch sensor electrode for detecting external objects in the inactive area of the display in accordance with an embodiment of the present invention.

FIG. 11 is a flow chart of illustrative steps involved in operating an electronic device having auxiliary sensors for detecting external objects near an input-output device in accordance with an embodiment of the present invention.

FIG. 12 is a flow chart of illustrative steps involved in operating an electronic device having auxiliary sensors for determining how the electronic device is being held by a user in accordance with an embodiment of the present invention.

### DETAILED DESCRIPTION

An electronic device may be provided with electronic components such as sensors, speakers, and microphones. Sensors may include, for example, proximity sensors, ambient light sensors, temperature sensors, and motion sensors.

Using sensors that measure the proximity of nearby objects, that measure ambient light levels, and/or that measure motion in objects such as a user's hand, control circuitry can control the operation of an electronic device. For example, the brightness of a display may be controlled based on ambient light levels. The functionality of the electronic device may be controlled based on how far the electronic device is located from external objects such as a user's head. When the electronic device is not in the vicinity of the user's head, for example, the electronic device can be operated in a normal mode in which a touch screen display is enabled. In response to detection of the presence of the electronic device in the vicinity of the user's head, the electronic device may be operated in a mode in which the touch screen is disabled or other appropriate actions are taken. Disabling touch sensing capabilities from the electronic device when the electronic device is near the user's head may help avoid inadvertent touch input as the touch sensor comes into contact with the user's ear and hair. Disabling display functions in the touch screen display when the electronic device is near the user's head may help conserve power and reduce user confusion about the status of the display.

The performance of input-output devices such as sensors, microphones, and speakers may change if a user's hand or finger is covering the input-output device. For example, if a user's hand is covering an ambient light sensor, the ambient light sensor may detect low light levels even in bright lighting conditions. If a microphone such as a noise canceling microphone is covered by an external object, the microphone may be unable to pick up ambient noise and noise cancellation operations may be negatively affected.

To address this issue, an electronic device may include auxiliary sensors around the periphery of the electronic device to help detect when an input-output device is covered by an external object and, if desired, to detect how an electronic device is being held. Control circuitry in the electronic device may in turn use this information to determine which actions should be taken to avoid comprising performance of the electronic device and its input-output devices.

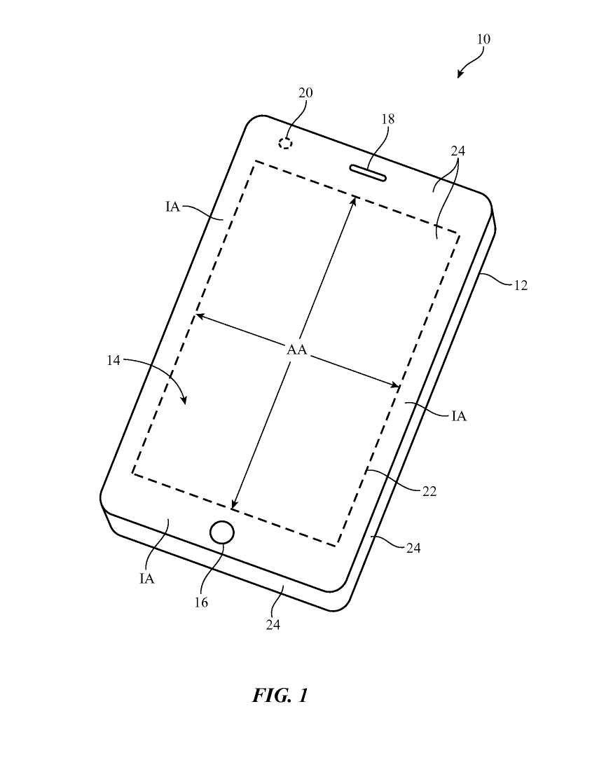

An illustrative electronic device that may be provided with auxiliary sensors is shown in FIG. 1. Electronic devices such as device 10 of FIG. 1 may be cellular telephones, media players, other handheld portable devices, somewhat smaller portable devices such as wrist-watch devices, pendant devices, or other wearable or miniature devices, gaming equipment, tablet computers, notebook computers, desktop computers, televisions, computer monitors, computers integrated into computer displays, or other electronic equipment.

As shown in the example of FIG. 1, device 10 may include a display such as display 14. Display 14 may be mounted in a housing such as housing 12. Housing 12 may have upper and lower portions joined by a hinge (e.g., in a laptop computer) or may form a structure without a hinge, as shown in FIG. 1. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies. The brightness of display 14 may be adjustable. For example, display 14 may include a backlight unit formed from a light source such as a lamp or light-emitting diodes that can be used to increase or decrease display backlight levels (e.g., to increase or decrease the brightness of the image produced by display pixels) and thereby adjust display brightness. Display 14 may also include organic light-emitting diode pixels or other pixels with adjustable intensities. In this type of display, display brightness can be adjusted by adjusting the intensities of drive signals used to control individual display pixels.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as speaker port 18.

In the center of display 14 (e.g., in the portion of display 14 within rectangular region 22 of FIG. 1), display 14 may contain an array of active display pixels. Region 22 may therefore sometimes be referred to as active area AA of display 14. The rectangular ring-shaped region that surrounds the periphery of active display region 22 may not contain any active display pixels and may therefore sometimes be referred to as inactive area IA of display 14. Inactive area IA may, for example, be a region of display 14 that does not emit light.

The display cover layer or other display layers in display 14 may be provided with an opaque masking layer in the inactive region to hide internal components from view by a user. Windows such as illustrative window 20 may be formed from openings in the opaque masking layer to accommodate light-based components. The windows may be free of opaque masking material so that light of all wavelengths may pass or may be covered with an ink or other material that is opaque in one part of the light spectrum while being transparent in another part of the light spectrum. For example, a window such as window 20 may be provided in an opaque masking layer that is formed from black ink or other material that is opaque in infrared and visible portions of the light spectrum. This window may be filled with an ink or other material that is transparent to infrared light but that is sufficiently opaque to visible light to block internal components in device 10 from view by a user.

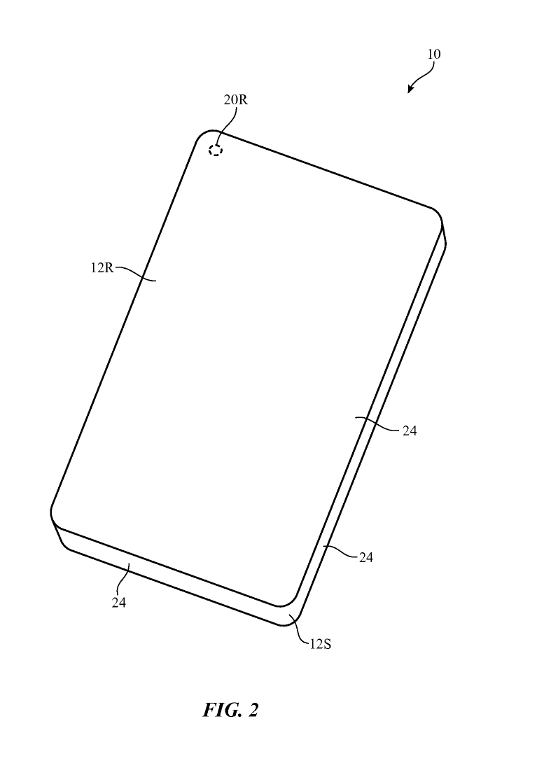

As shown in the rear perspective view of device 10 of FIG. 2, housing 12 may have an opposing rear surface such as a planar surface associated with opposing rear housing structure 12R. Rear housing structure 12R, which may sometimes be referred to as a rear housing member, rear housing wall, or planar housing member) may be formed from glass, ceramic, plastic, metal, carbon-fiber composites or other fiber-based composites, other materials, or a combination of two or more of any of these materials.

Device 10 may be provided with structures such as window structure 20R that are associated with a camera, sensor, or other optical component, a microphone, a speaker, or other audio component (e.g., an audio component in an acoustic port such as ports 21 and 24 of FIG. 1), or other electrical component in device 10. Structure 20R may include an optically transparent window to allow light to reach a camera image sensor or to exit or enter other light-based components, an acoustically transparent window such as an acoustic mesh structure to allow sound to reach a microphone or to exit a speaker or to otherwise accommodate an audio device, or may have other structures associated with the housing and use of an electrical component. In the example of FIG. 2, structure 20R has been formed in the upper left portion of the rear of housing 12. This is merely illustrative. Structures such as structure 20R may be formed elsewhere on the rear housing structure 12R, on the front of housing 12, on sidewalk 12S of housing 12, or two or more of these surfaces of device 10, etc.

Electronic device 10 may include multiple touch-sensitive surfaces 24. For example, touch-sensitive surfaces 24 may be formed on the front of electronic device 10 (e.g., in active area AA and/or in inactive area IA), may be formed on the sidewalls of electronic device 10 (e.g., on sidewalls 12R), and/or may be formed on back of electronic device 10 (e.g., on rear housing member 12R). All of the exterior surfaces of electronic device 10 may be touch-sensitive or only select portions of the exterior surface of electronic device 10 may be touch-sensitive. If desired, touch-sensitive surfaces 24 may be selectively activated. For example, in some modes of operation, some or all of touch-sensitive surfaces 24 may be inactive (e.g., may be insensitive to touch). In other modes of operation, some or all of touch-sensitive surfaces 24 may be active (e.g., may be sensitive to touch).

Some of touch-sensitive surfaces 24 may form auxiliary sensors that are used to detect when an input-output device in electronic device 10 is covered by an external object and/or to detect how electronic device 10 is being held by a user. For example, electronic device 10 may include a primary touch sensor such as a touch sensor associated with active area AA of FIG. 1 and may include auxiliary touch sensors outside of active area AA. The touch sensor associated with active area AA may primarily be used for receiving touch input from user, while auxiliary touch sensors outside of active area AA may be used for gathering information about how and where a user is holding electronic device 10. This is, however, merely illustrative. In general, any one of touch-sensitive surfaces 24 may be used for receiving touch input from a user and/or gathering information about how and where a user is holding electronic device 10.

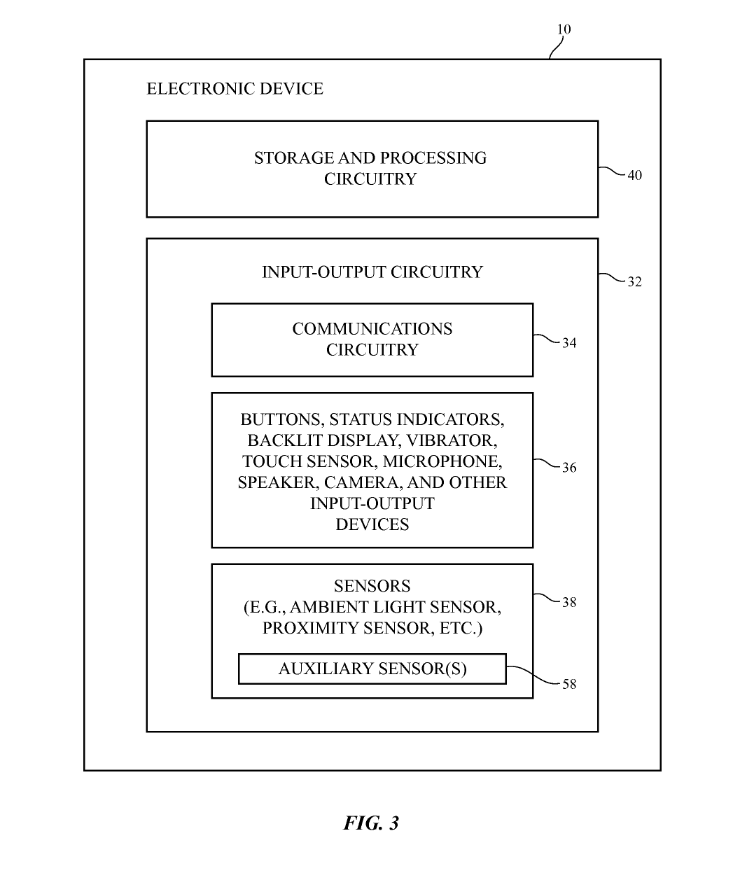

A schematic diagram of device 10 showing how device 10 may include sensors and other components is shown in FIG. 3. As shown in FIG. 3, electronic device 10 may include control circuitry such as storage and processing circuitry 40. Storage and processing circuitry 40 may include one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 40 may be used in controlling the operation of device 10. The processing circuitry may be based on a processor such as a microprocessor and other suitable integrated circuits. With one suitable arrangement, storage and processing circuitry 40 may be used to run software on device 10 such as internet browsing applications, email applications, media playback applications, operating system functions, software for capturing and processing images, software implementing functions associated with gathering and processing sensor data, software that makes adjustments to display brightness and touch sensor functionality, etc.

Input-output circuitry 32 may be used to allow data to be supplied to device 10 and to allow data to be provided from device 10 to external devices.

Input-output circuitry 32 may include wired and wireless communications circuitry 34. Communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Input-output circuitry 32 may include input-output devices 36 such as button 16 of FIG. 1, joysticks, click wheels, scrolling wheels, a touch screen such as display 14 of FIG. 1, other touch sensors such as track pads or touch-sensor-based buttons, vibrators, audio components such as microphones and speakers, image capture devices such as a camera module having an image sensor and a corresponding lens system, keyboards, status-indicator lights, tone generators, key pads, and other equipment for gathering input from a user or other external source and/or generating output for a user.

Sensor circuitry such as sensors 38 of FIG. 3 may include an ambient light sensor for gathering information on ambient light levels, proximity sensor components (e.g., light-based proximity sensors and/or proximity sensors based on other structures), accelerometers, gyroscopes, magnetic sensors, and other sensor structures. Sensors 38 may include auxiliary sensors 58 for detecting external objects near input-output devices and for determining how a device is being held in the hands of a user. Auxiliary sensors 58 may be formed around the periphery of electronic device 10 (e.g., on one, two, three, or more than three sides of electronic device 10). Sensors 38 of FIG. 3 may include one or more microelectromechanical systems (MEMS) sensors (e.g., accelerometers, gyroscopes, microphones, force sensors, pressure sensors, capacitive sensors, or any other suitable type of sensor formed using a microelectromechanical systems device). If desired, other suitable components in device 10 may be formed using microelectromechanical systems technology.

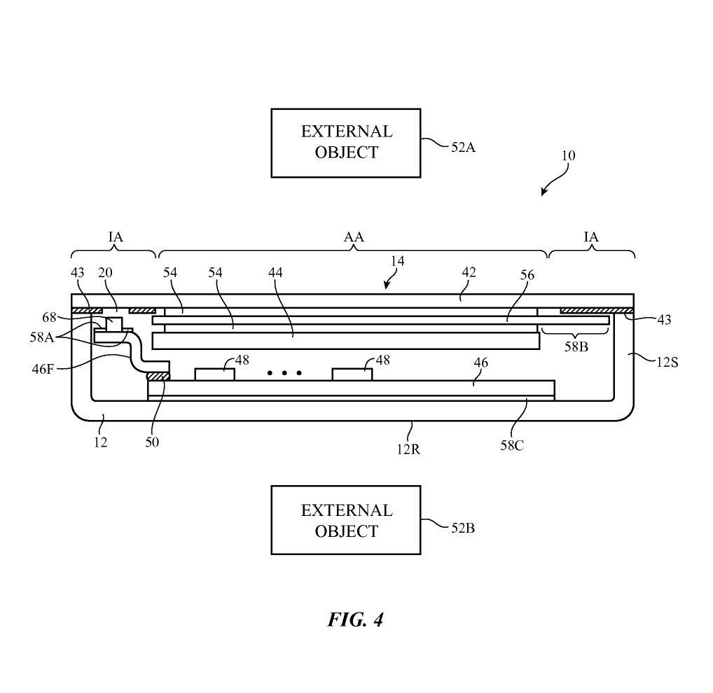

A cross-sectional side view of electronic device 10 is shown in FIG. 4. As shown in FIG. 4, display 14 may be mounted in housing 12. Display structures 44 such as a liquid crystal display module, an organic light-emitting diode display layer, or other display structures that include an array of active display pixels may be formed under display cover layer 42 in active area AA of display 14. Display structures 44 may include polarizer layers, color filter layers, thin-film transistor layers, adhesive layers, layers of liquid crystal material, or other structures for producing images on display 14. Display cover layer 42 may be formed from a clear glass layer, a layer of transparent plastic, or other cover layer material. A layer of ink (e.g., black ink or white ink or ink of other colors) such as opaque masking layer 43 may be formed on the underside of display cover layer 42 in inactive area IA.

As shown in FIG. 4, display 14 may include one or more layers of touch-sensitive components such as touch sensor 56 attached to cover layer 42. Touch sensor 56 may be attached to cover layer 42 using an adhesive material such as optically clear adhesive (OCA) 54. Adhesive 54 may be a liquid adhesive, light-cured adhesive, pressure-sensitive adhesive or other suitable adhesive. Touch sensor 56 may include touch sensor components such as an array of capacitive touch sensor electrodes formed from transparent conductive materials such as indium tin oxide. Display structures 44 may be attached to touch sensor 56 using optically clear adhesive 54.

One or more sensor windows such as sensor window 20 may be formed in opaque masking layer 43. Sensor window 20 may be devoid of opaque masking material or may be filled with a layer of material that is transparent at some wavelengths (e g, infrared wavelengths) while being opaque at other wavelengths (e.g., visible wavelengths).

Sensor structures 68 such as light sources, light detectors, and other structures may be mounted under opaque masking material 43 in alignment with windows such as window 20. Communications paths such as metal lines on dielectric substrates may be used in interconnecting sensor structures 68 with processing circuitry in device 10. As an example, sensors 68 may be mounted on a substrate such as substrate 46F. Substrate 46F may be coupled to additional substrates in device 10 such as illustrative substrate 46 using connectors such as connector 50 (e.g., a board-to-board connector or other connection structures).

Device 10 may have electrical components such as components 48. Components 48 may include integrated circuits, buttons, connectors, sensors, and other circuitry of the type shown in FIG. 3. Components 48 may be mounted on one or more substrates such as substrate 46 and/or substrate 46F. Substrates 46 and 46F may be dielectric carriers such as molded plastic carriers or may be printed circuits. For example, substrates 46 and 46F may be printed circuits such as rigid printed circuit boards formed from a material such as fiberglass-filled epoxy or flexible printed circuits formed from sheets of polyimide or other flexible polymer layers.

During operation of device 10, external objects such as external object 52A and 52B may be placed in the vicinity of device 10. External objects 52A and 52B may be parts of a user's body, may be parts of a user's clothing, or may be other external objects. For example, in a scenario in which a user is placing device 10 in the vicinity of the user's head (e.g., within 5 cm, within 3 cm, or within other distances), external object 52A may be an ear on the side of the user's head. In other scenarios, external objects 52A and/or 52B may be a user's finger or hand (e.g., in a configuration in which a user is making a hand motion in the vicinity of device 10 to supply a command to device 10).

Sensor structures 68 may include an ambient light sensor that measures ambient light levels in the vicinity of electronic device 10. The brightness of the display may be controlled using sensor signals from ambient light sensor 68. For example, the brightness of display 14 may be decreased in dim ambient lighting conditions and may be increased in bright ambient lighting conditions.

Sensor structures 68 may include a proximity sensor that monitors external objects. For example, a proximity sensor may detect whether or not the external object is present in the vicinity of device 10 (e.g., within a given distance of sensor structures 68). Device 10 may, for example, determine whether device 10 is being held against the ear of a user.

Electronic device 10 may include auxiliary sensors 58 for detecting when an input-output device is covered and/or for determining how electronic device 10 is being held by a user. Auxiliary sensors 58 may be distributed uniformly at the periphery of electronic device 10 (e.g., in the inactive area IA that surrounds active area AA) or may be formed in select regions of electronic device 10 (e.g., localized around a particular input-output device). Sensors 58 may include touch sensors that detect when a user touches or nearly touches a particular region of device 10, proximity sensors that detect when an external object is in the vicinity of device 10, or other suitable sensors for detecting the presence of a user's hands or fingers in a given region of device 10. Auxiliary sensors 58 may be formed from force sensors, from switches or other mechanical sensors, from capacitive sensors, from resistance-based sensors, from light-based sensors, and/or from acoustic-based sensors such as ultrasonic acoustic-based sensors (as examples).

Auxiliary sensors 58 may, for example, be formed from touch sensor elements. The touch sensor elements that form touch sensors 58 may be based on any suitable touch sensor technology such as acoustic touch technology, force-sensor-based touch technology, resistive touch technology, or capacitive touch technology (as examples). In capacitive touch sensors, capacitive electrodes may be formed from a conductive material. For example, for use in display applications in which the touch sensor electrodes are transparent to allow a user to view an underlying display, the touch sensor electrodes may be formed from a transparent conductive material such as indium tin oxide. Configurations in which touch sensors 58 are capacitive touch sensors and in which touch sensor electrodes for touch sensors 58 are formed from transparent conductive materials are sometimes described herein as an example. Other types of arrangements may be used for touch sensor 12 if desired (e.g., arrangements with non-capacitive sensors, arrangements with capacitive electrodes formed from materials other than indium tin oxide, touch sensor electrodes formed from non-transparent metal, etc.).

Touch sensors 58 may be used to detect touches near electronic components that are mounted in the inactive area of the display. For example, touch sensors 58 may create touch-sensitive regions around speaker 18 of FIG. 1, around button 16 of FIG. 1, around sensors such as sensors behind window 20 of FIG. 1, and/or around sensors such as sensors mounted behind rear windows 20R of FIG. 2.

Some auxiliary sensors such as auxiliary sensor 58A may be localized around an input-output device such as sensor 68. Forming auxiliary sensor 58A near sensor 68 may enhance the performance of sensor 68. For example, sensor 68 may be an ambient light sensor and auxiliary sensor 58A may detect when external object 52A is covering ambient light sensor 68. When control circuitry in electronic device 10 (e.g., control circuitry in storage and processing circuitry 40 of FIG. 3) receives information from auxiliary sensor 58A indicating that ambient light sensor 68 is covered, the control circuitry may take appropriate action. For example, the control circuitry may disable ambient light sensor 68 (e.g., may discontinue gathering ambient light data while sensor 68 is obstructed), may rely on historical data from ambient light sensor 68 (e.g., data that was gathered prior to ambient light sensor 68 being obstructed) to determine the optimal brightness for display 14, or the control circuitry may use data from a different sensor that is not covered (e.g., a second ambient light sensor or other sensor in device 10 that can gather ambient light information).

In the example of FIG. 4, auxiliary sensor 58A is formed on the same flexible printed circuit 46F on which sensor 68 is mounted. Sensor 58A may, for example, surround or partially surround sensor 68 on flexible printed circuit 46F. This is, however, merely illustrative. In general, auxiliary sensor 58A may be formed in any suitable location near sensor 68 (e.g., may be formed on an interior surface of cover layer 42, may be formed on a separate layer near sensor 68, etc.). If desired, sensor 58A may be formed as an extension of touch sensor 56 (e.g., touch sensor 56 may extend under the inactive area IA around opening 20 to form touch-sensitive regions around opening 20).

Some auxiliary sensors such as sensors 58B may be formed using already existing sensors. For example, touch sensor 56 may have a first region in active area AA with touch sensor electrodes for receiving touch input from a user and a second region in inactive area IA with touch sensor electrodes for forming auxiliary sensor 58B. Auxiliary sensor 58B may be formed from an extended portion of touch sensor 56 that extends to the edges of electronic device 10 (e.g., touch sensor 56 may have one or more edges that extends to housing sidewalls 12S). Extending touch sensor 56 to the edges of electronic device 10 creates touch-sensitive regions in inactive area IA that can be used to gather information on how electronic device 10 is being held by a user (e.g., whether electronic device 10 is being held by one hand, by two hands, by a right hand or left hand, etc.). Touch sensor 56 may have one side, two sides, three sides, or four sides that extend under opaque masking material 43 in inactive area IA to form auxiliary sensors 58B.

If desired, some of auxiliary touch sensors 58 such as sensor 58C may be formed adjacent to rear housing wall 12R to form a touch-sensitive region on the rear surface of electronic device 10. Rear sensor 58C may be formed on a backside of printed circuit 46, may be formed on an interior surface of rear housing wall 12R, or may be formed as a separate layer in between printed circuit 46 and rear housing wall 12R.

Auxiliary sensors 58C on rear housing wall 12R of device 10 may be used to detect external objects near the back of device 10 such as external object 52B. Control circuitry 40 (FIG. 3) may use information from rear sensors 58C to determine how electronic device is being held and/or to determine whether any input-output devices on the backside of device 10 are covered by an external object. Information from sensors 58C may indicate that the backside of device 10 is resting against a user's arm, a user's wrist, a user's hand, etc. Information from rear sensors 58C may, if desired, be combined with information from front sensors 58A and 58B to determine additional information. For example, if all of auxiliary sensors 58 (e.g., front sensors 58A and 58B and rear sensors 58C) detect external objects or surfaces in the vicinity of device 10, control circuitry 40 may determine that device 10 is in a user's pocket or bag.

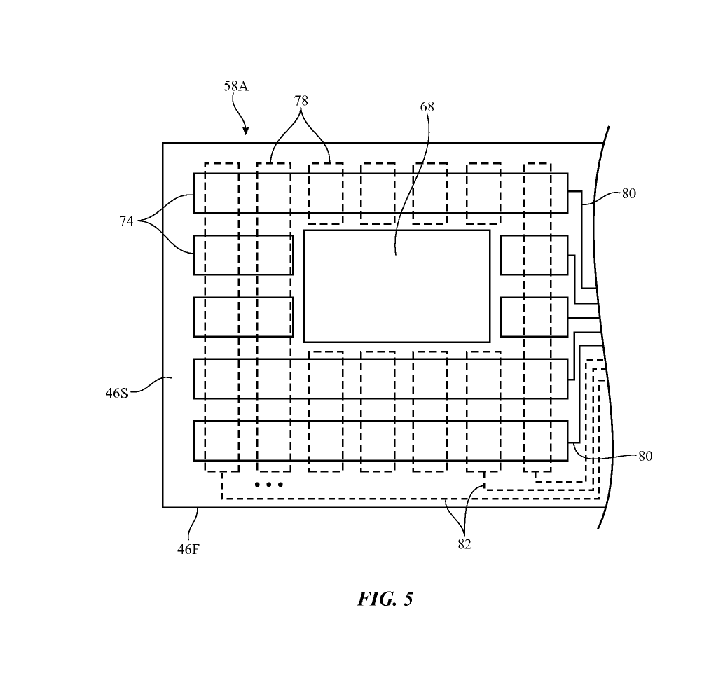

An illustrative configuration for sensor 58A of FIG. 4 is shown in Ha 5. As shown in FIG. 5, sensor 68 may be mounted to upper surface 46S of substrate 46F (e.g., a flexible printed circuit substrate or other suitable substrate). Sensor 58A may also be formed on upper surface 46S of substrate 46F and may surround or at least partially surround sensor 68 on substrate 46F.

Sensor 58A may be formed from capacitive touch sensor electrodes such as electrodes 74 and 78 on substrate 46F. Electrodes 74 and 78 may have any suitable shape (e.g., square, diamond, elongated rectangles, etc.). In the illustrative configuration of FIG. 5, electrodes 74 and 78 have the shape of elongated rectangles (i.e., strips). Electrodes 74 extend horizontally to form rows. Electrodes 78 extend vertically to form columns. By monitoring capacitance changes associated with the horizontal and vertical electrodes, touch sensor 58A may be used to ascertain the location of an external object such as a finger or hand (e.g., when a user of device 10 brings a hand in contact with or in close proximity to cover glass 42 near sensor 68).

Conductive lines such as conductive lines 80 may each be coupled to a respective one of electrodes 74 and conductive lines 82 may each be coupled to a respective one of electrodes 78. Conductive lines 80 and 82 may be routed from touch sensor 58A to control circuitry (e.g., on printed circuit 46 of FIG. 4).

Conductive electrodes 78 and 74 may, if desired, be formed on the same side of substrate 46F. In this type of arrangement, an intervening dielectric coating layer may be used to prevent electrodes 78 and 74 from being shorted to each other. In the illustrative configuration of FIG. 5, electrodes 78 and 74 are formed on opposing surfaces of substrate 46F. In particular, electrodes 74 and associated signal routing lines 80 have been formed on the upper surface of substrate 46F, whereas electrodes 78 and associated signal routing lines 82 have been formed on the lower surface of substrate 46F.

Conductive lines 80 and 82 may be formed from conductive material such as metal (e.g., copper) transparent conductive material such as indium tin oxide, or other conductive substances. For example, conductive lines 80 and 82 may be copper lines, indium tin oxide lines, or lines that include a lower layer of indium tin oxide and an upper layer of copper (as examples).

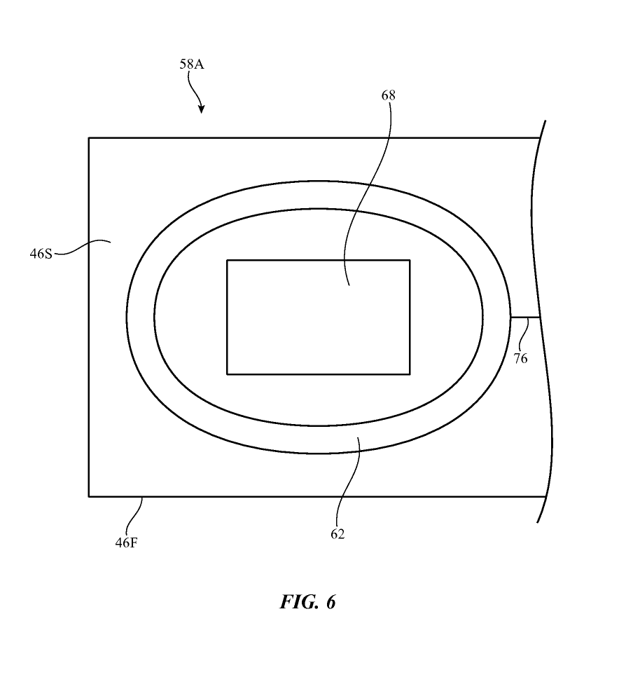

Touch sensor 58A may have a resolution that matches the resolution of touch sensor 56 of FIG. 4 or may have a different resolution than that of touch sensor 56. The example of FIG. 5 in which touch sensor 58A includes horizontal rows and vertical columns of touch sensor electrodes for detecting the location of an external object in the vicinity of sensor 68 is merely illustrative. If desired, touch sensor 58 may include a reduced number of touch sensor electrodes, as shown in FIG. 6.

In the example of FIG. 6, touch sensor 58A is formed from a single capacitive touch sensor electrode 62 on upper surface 46S of substrate 46F. Touch sensor electrode 62 has an oval shape that surrounds sensor 68. Sensor 58A of FIG. 6 may have reduced touch resolution compared to that of sensor 58A of FIG. 5 but may be sufficient for detecting when external objects are in the vicinity of sensor 68. Conductive lines such as conductive line 76 may be coupled to touch sensor electrode 62 and may be used to route sensor signals between electrode 62 and control circuitry (e.g., on printed circuit 46 of FIG. 4).

The oval shape of electrode 62 in FIG. 6 is merely illustrative. If desired, touch sensor 58A may be formed from electrodes with rectangular shapes, circular shapes or other ring shapes, square shapes, or other suitable shapes.

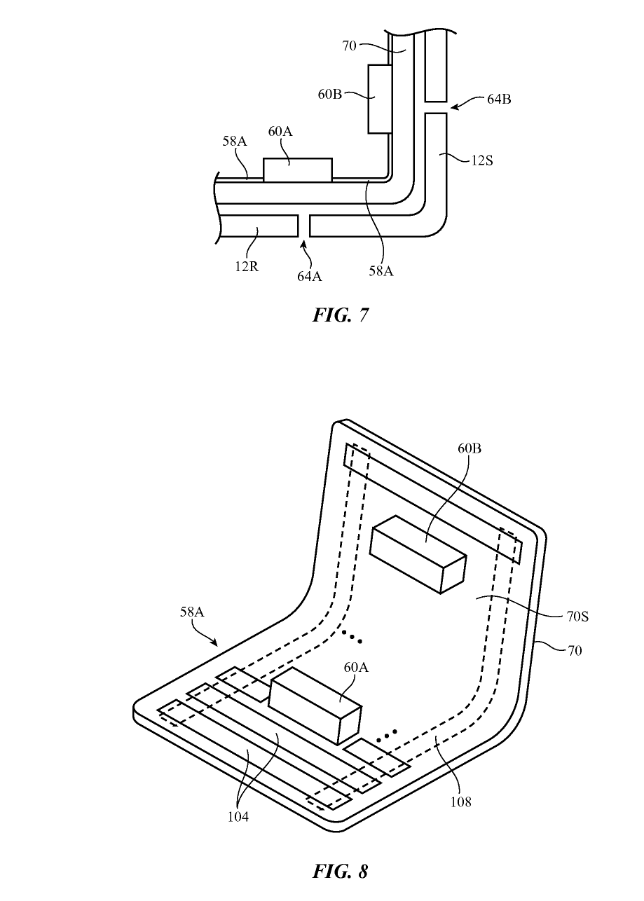

Auxiliary sensors 58A may be formed near other input-output devices such as audio devices (e.g., speakers and microphones). FIG. 7 shows how audio devices may be mounted near different audio ports in housing 12. For example, a first audio device 60A may be mounted near audio port 64A, while a second audio device 60B may be mounted near audio port 64B. In the example of FIG. 7, audio port 64A is formed in a rear housing wall 12R while audio port 64B is formed in a housing sidewall 12S. This is, however, merely illustrative. If desired, audio ports 64A and 64B may both be formed in housing sidewall 12S, may both be formed in rear housing wall 12R, or may be formed in any suitable portion of device 10 (e.g., one port may be formed in a housing sidewall on one end of device 10 white another port may be formed in a housing sidewall on an opposing end of device 10).

Audio devices 60A and 60B may be mounted on a common substrate such as substrate 70 (e.g., a flexible printed circuit substrate) or may be mounted on separate substrates. Audio devices 60A and 60B may be speakers or may be microphones (e.g., noise cancellation microphones or voice microphones). Audio devices 60A and 60B may be used simultaneously to convey audio signals or may be used one at a time.

Auxiliary sensor 58A may be formed adjacent to audio devices 60A and 60B and may be used in detecting when one or both of audio ports 64A and 64B are covered by an eternal object. When control circuitry in electronic device 10 receives signals from sensor 58A indicating that one of the audio ports is covered by an external object (e.g., a user's hand), control circuitry may use an alternative (unobstructed) audio device to present audio signals to or receive audio signals from a user. For example, when audio port 64A becomes covered by a user's hand, electronic device 10 may use audio device 60B to present or receive audio. When audio port 64B becomes covered by a user's hand, electronic device 10 may use audio device 60A to present or receive audio.

An illustrative configuration for sensor 58A of FIG. 7 is shown in FIG. 8. As shown in FIG. 8, audio devices 60A and 60B may be mounted to upper surface 70S of substrate 70. Sensor 58A may also be formed on upper surface 70S of substrate 70 and may surround or at least partially surround audio devices 60A and 60B on substrate 70.

Sensor 58A may be formed from capacitive electrodes such as electrodes 104 and 108 on substrate 70. Electrodes 104 and 108 may have any suitable shape (e.g., square, diamond, elongated rectangles, etc.). In the illustrative configuration of FIG. 8, electrodes 104 and 108 have the shape of elongated rectangles (i.e., strips). Electrodes 104 extend horizontally to form rows. Electrodes 108 extend vertically to form columns. By monitoring capacitance changes associated with the horizontal and vertical electrodes, touch sensor 58A may be used to ascertain the location of an external object such as a finger or hand (e.g., when a user of device 10 brings a hand in contact with or in close proximity to audio ports 64A and/or 64B).

Conductive lines may each be coupled to a respective one of electrodes 104 and electrodes 108. Conductive lines may be routed from touch sensor 58A to control circuitry (e.g., on printed circuit 46 of FIG. 4).

Conductive electrodes 104 and 108 may, if desired, be formed on the same side of substrate 70. In this type of arrangement, an intervening dielectric coating layer may be used to prevent electrodes 104 and 108 from being shorted to each other. In the illustrative configuration of FIG. 8, electrodes 104 and 108 are formed on opposing surfaces of substrate 70. In particular, electrodes 104 and associated signal routing lines have been formed on the upper surface of substrate 70, whereas electrodes 108 and associated signal routing lines have been formed on the lower surface of substrate 70. Conductive lines on substrate 70 may be formed from conductive material such as metal (e.g., copper), transparent conductive material such as indium tin oxide, or other conductive substances. For example, conductive lines on substrate 70 may be copper lines, indium tin oxide lines, or lines that include a lower layer of indium tin oxide and an upper layer of copper (as examples).

Touch sensor 58A may have a resolution that matches the resolution of touch sensor 56 of FIG. 4 or may have a different resolution than that of touch sensor 56. The example of FIG. 8 in which touch sensor 58A includes horizontal rows and vertical columns of touch sensor electrodes for detecting the location of an external object in the vicinity of audio devices 60A and 60B is merely illustrative. If desired, touch sensor 58A may include a reduced number of touch sensor electrodes. For example, touch sensor 58A may be formed from a single capacitive touch sensor electrode (e.g., similar to the example of FIG. 6). Touch sensor electrodes with a single touch sensor electrode may have reduced touch resolution compared to that of sensor 58A of FIG. 8 but may be sufficient for detecting when external objects are in the vicinity of audio ports 64A and 64B.

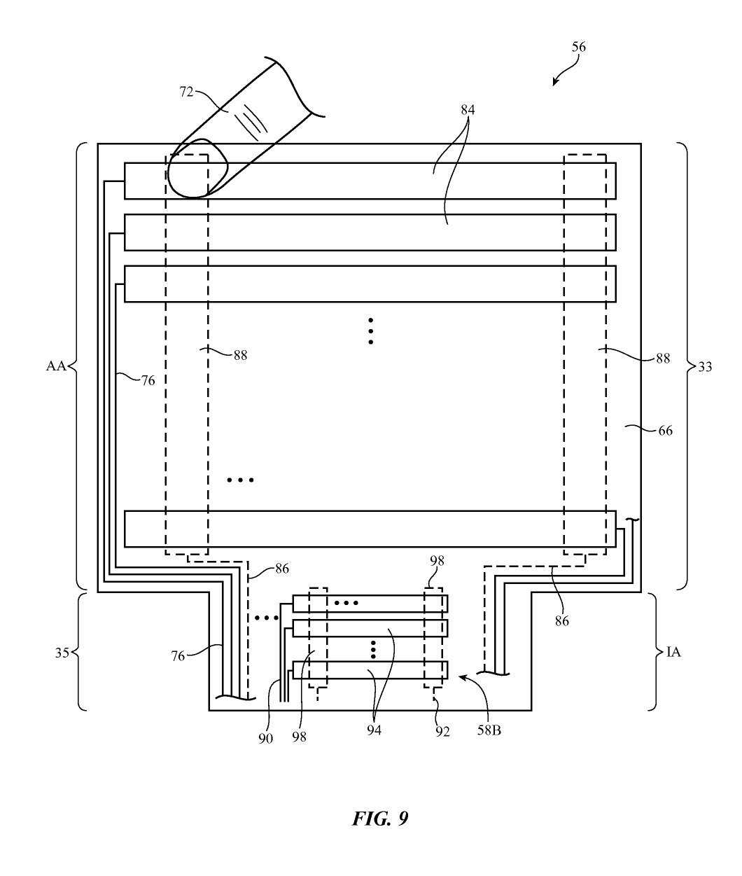

An illustrative configuration for sensor 58B of FIG. 4 is shown in FIG. 9. As shown in FIG. 9, touch sensor 58B may be formed as an extension of touch sensor 56. Touch sensor 56 may include capacitive electrodes such as electrodes 84 and 88 formed on main portion 33 of substrate 66. Electrodes 84 and 88 may have any suitable shape (e.g., square, diamond, elongated rectangle, etc.). In the illustrative configuration of FIG. 9, electrodes 84 and 88 have the shape of elongated rectangles (i.e., strips). Electrodes 84 extend horizontally to form rows. Electrodes 88 extend vertically to form columns. By monitoring capacitance changes associated with the horizontal and vertical electrodes, touch sensor 56 may be used to ascertain the location of an external object such as finger 72 during a touch event (i.e., when a user of device 10 brings finger 72 in contact with cover glass 42 or otherwise brings finger 72 into close proximity to sensor 56).

Conductive lines such as conductive lines 76 may each be coupled to a respective one of electrodes 84 and may be routed from main portion 33 (e.g., a rectangular planar portion) of substrate 66 to protruding portion 35. Conductive lines 86 may each be coupled to a respective one of electrodes 88 and may likewise be routed from main portion 33 to protruding portion 35. In protruding portion 35 (sometimes referred to as a flex tail), signal lines such as lines 76 and 86 may run parallel to each other and may form signal buses (i.e., protruding portion 35 may form an integral flexible printed circuit bus for touch sensor 56).

Conductive electrodes 84 and 88 may, if desired, be formed on the same side of substrate 66. In this type of arrangement, an intervening dielectric coating layer may be used to prevent electrodes 88 and 84 from being shorted to each other. In the illustrative configuration of FIG. 9, electrodes 84 and 88 are formed on opposing surfaces of substrate 66. In particular, electrodes 84 and associated signal routing lines 76 have been formed on the upper surface of substrate 66, whereas electrodes 88 and associated signal routing lines 86 have been formed on the lower surface of substrate 66.

Conductive lines 76 and 86 may be formed from conductive material such as metal (e.g., copper), transparent conductive material such as indium tin oxide, or other conductive substances. For example, conductive lines 76 and 86 may be copper lines, indium tin oxide lines, or lines that include a lower layer of indium tin oxide and an upper layer of copper (as examples).

Touch sensor 58B may include capacitive electrodes such as electrodes 94 and 98 formed on protruding portion 35 of substrate 66. Electrodes 94 and 98 may have any suitable shape (e.g., square, diamond, elongated rectangle, etc.). In the illustrative configuration of FIG. 9, electrodes 94 and 98 have the shape of elongated rectangles (i.e., strips). Electrodes 94 extend horizontally to form rows. Electrodes 98 extend vertically to form columns. By monitoring capacitance changes associated with the horizontal and vertical electrodes, touch sensor 58B may be used to ascertain the location of an external object such as finger 72 (i.e., when a user of device 10 brings finger 72 in contact with or in close proximity to cover glass 42 in inactive area IA). Since users often hold portable electronic devices at the edges of the display (e.g., in inactive regions IA), the presence of touch sensor 58B in inactive area IA can be used in detecting where and how electronic device 10 is being held by a user.

Conductive lines such as conductive lines 90 may each be coupled to a respective one of electrodes 94 and conductive lines 92 may each be coupled to a respective one of electrodes 98. Conductive lines 90 and 92 may be routed from touch sensor 58B to control circuitry in electronic device 10.

Conductive electrodes 94 and 98 of sensor 58B may, if desired, be formed on the same side of substrate 66. In this type of arrangement, an intervening dielectric coating layer may be used to prevent electrodes 94 and 98 from being shorted to each other. In the illustrative configuration of FIG. 9, electrodes 94 and 98 are formed on opposing surfaces of substrate 66. In particular, electrodes 94 and associated signal routing lines 90 have been formed on the upper surface of substrate 66, whereas electrodes 98 and associated signal routing lines 92 have been formed on the lower surface of substrate 66.

Conductive lines 90 and 92 of sensor 58B may be formed from conductive material such as metal (e.g., copper), transparent conductive material such as indium tin oxide, or other conductive substances. For example, conductive lines 90 and 92 may be copper lines, indium tin oxide lines, or lines that include a lower layer of indium tin oxide and an upper layer of copper (as examples).

Conductive lines 76 and 86 of touch sensor 56 may be routed in such a way as to accommodate sensor 58B in extended portion 35. For example, touch sensor 56B may be formed in a gap between signal lines 76 and 86 in portion 35.

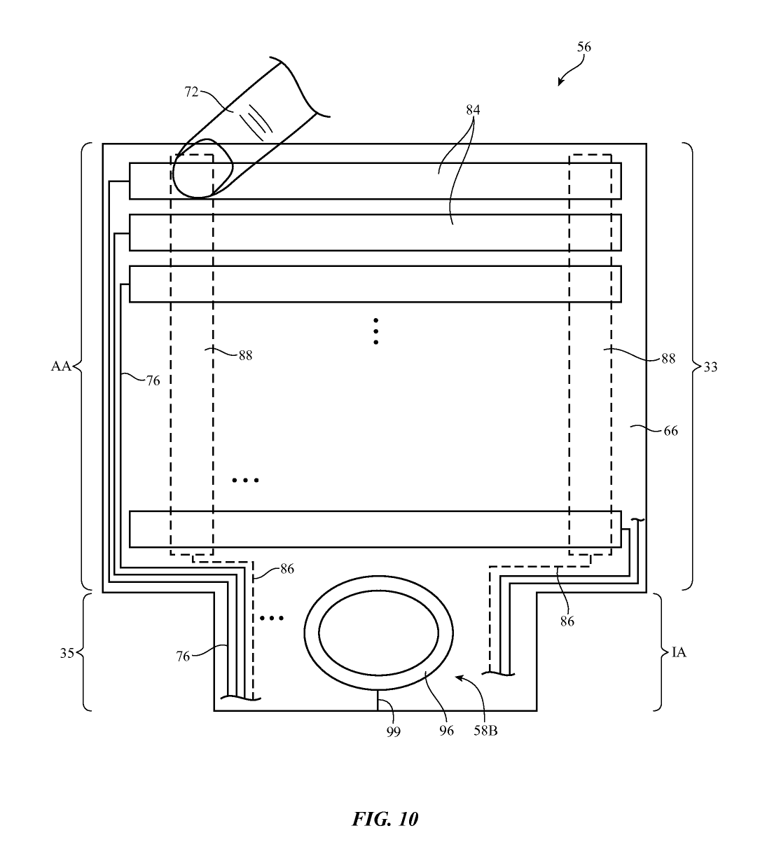

Touch sensor 58B may have a resolution that matches the resolution of touch sensor 56 of or may have a different resolution than that of touch sensor 56. The example of FIG. 9 in which touch sensor 58B includes horizontal rows and vertical columns of touch sensor electrodes for detecting the location of an external object in the vicinity of inactive area IA is merely illustrative. If desired, touch sensor 58B may include a reduced number of touch sensor electrodes, as shown in FIG. 10.

In the example of FIG. 10, touch sensor 58B is formed from a single capacitive touch sensor electrode 96 in portion 35 of substrate 66. Touch sensor electrode 96 may have an oval shape and may occupy a space between signal lines 76 and 86 in portion 35. Sensor 58B of FIG. 10 may have reduced touch resolution compared to that of sensor 58B of FIG. 9 but may be sufficient for detecting when external objects are in proximity to inactive area IA. Conductive lines such as conductive line 99 may be coupled to touch sensor electrode 96 and may be used to route sensor signals between electrode 96 and control circuitry (e.g., on printed circuit 46 of FIG. 4).

The oval shape of electrode 96 in FIG. 10 is merely illustrative. If desired, touch sensor 58B may be formed from electrodes with rectangular shapes, circular shapes or other ring shapes, square shapes, or other suitable shapes.

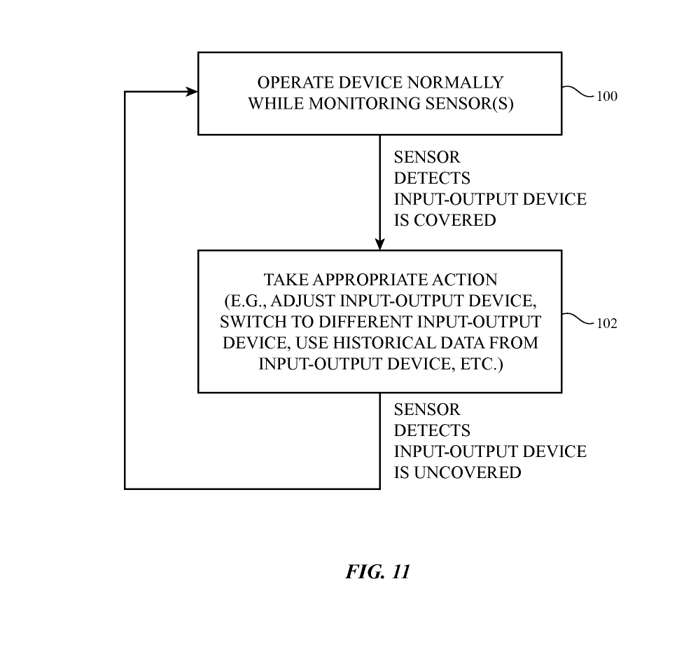

FIG. 11 is a flow chart of illustrative steps involved in operating an electronic device having auxiliary sensors localized around input-output devices such as sensors and audio devices. During the operations of step 100, electronic device 10 may be operated normally while using auxiliary sensors 58 to monitor for the presence of an external object near one or more input-output devices such as sensors (e.g., ambient light sensors, proximity sensors, etc.) and audio devices (e.g., speakers and microphones). Circuitry 40 (FIG. 3) may be used in evaluating sensor data and taking appropriate action.

Examples of operations that may be performed by device 10 during step 100 include audio-based operations (e.g., playing media content using one or more speakers in electronic device 10, providing a user with audio associated with a telephone call, providing audio associated with a video chat session, or otherwise presenting audio content through speakers in device 10), noise cancelling operations (e.g., gathering ambient noise signals using one or more microphones in electronic device 10), ambient light sensing operations (e.g., gathering ambient light signals using one or more ambient light sensors in electronic device 10), or other suitable operations.

During the monitoring operation of step 100, device 10 can use auxiliary sensors 58 to detect when input-output devices in electronic device 10 (e.g., input-output devices around which sensors 58 are formed) become covered by an external object. If it is determined that one or more of the input-output devices around which sensors 58 are formed has been covered by an external object, device 10 can take appropriate action at step 102.

As an example, in response to determining that an ambient light sensor is obstructed by a user's hand, control circuitry 40 may rely on historical data from the ambient light sensor (e.g., data that was gathered prior to the ambient light sensor being covered) to determine the optimal brightness for the display, or control circuitry 40 may use data from a different sensor that is not covered (e.g., a second ambient light sensor or other sensor in device 10 that can gather ambient light information).

In response to determining that a microphone port associated with a microphone (e.g., a noise cancellation microphone) is obstructed by an external object such as a user's hand, control circuitry 40 may gather microphone signals using a different microphone or may otherwise adjust noise cancellation operations to account for the obstruction of the microphone.

In response to determining that a speaker port associated with a speaker is obstructed by a user's hand, control circuitry 40 may use a different speaker to present audio signals to a user and/or control circuitry 40 may automatically switch the type of audio playback scheme that is being used from stereo sound to mono sound. For example, if multiple speakers in electronic device 10 are used to present stereo audio to a user prior to one speaker being covered, the use of a stereo playback scheme may no longer be appropriate if one or more speakers is obstructed as the user may miss information that is being sent to the obstructed speaker. Other actions may be taken in response to detecting that one or more input-output devices in electronic device 10 is obstructed, if desired. These examples are merely illustrative.

Following the operations of step 102, control circuitry 40 may continue monitoring sensors 58 to determine when the input-output device is no longer obstructed. In response to determining that the input-output device is no longer obstructed, operations may return to step 100, where device 10 may be operated normally without obstructed input-output devices. This may include, for example, resuming use of the uncovered input-output device.

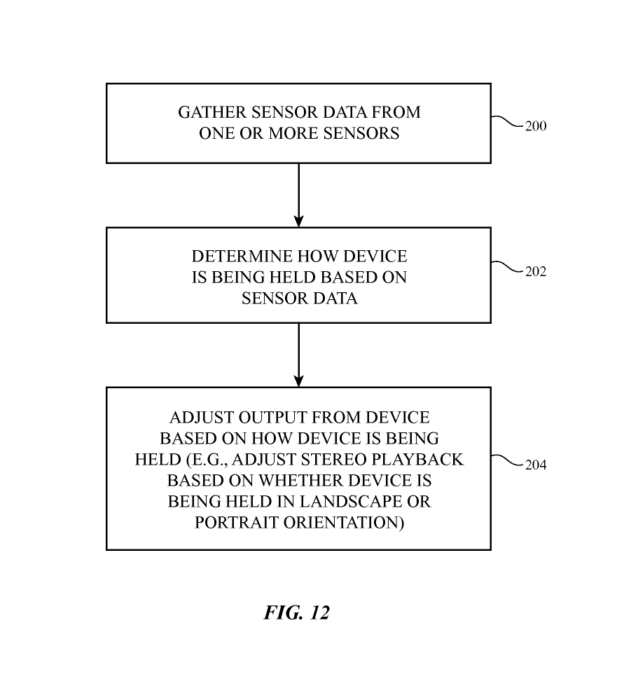

FIG. 12 is a flow chart of illustrative steps involved in operating an electronic device having auxiliary sensors around the periphery of the electronic device for determining how the electronic device is being held by a user.

At step 200, control circuitry 40 in electronic device 10 may gather sensor data from auxiliary sensors 58. Auxiliary sensors 58 may be located in regions where a user typically places his or her hands while holding electronic device 10 (e.g., around the periphery of the display). Sensors 58 may, for example, be touch sensors and/or proximity sensors that detect the proximity or touch or a user's hand or finger.

At step 202, control circuitry 40 may determine how electronic device 10 is being held by a user based on sensor data from sensors 58. For example, if information from sensors 58 indicates that a user's hands are holding the top and bottom of electronic device 10, control circuitry 40 may determine that electronic device 10 is being held in a landscape orientation, which may in turn indicate that input-output devices in the top or bottom regions of device 10 are obstructed. If information from sensors 58 indicates that a user's hands are holding the left side and/or right side of electronic device 10, control circuitry 40 may determine that electronic device 10 is being held in a portrait orientation, which may in turn indicate that input-output devices in the left or right regions of device 10 are obstructed.

At step 204, control circuitry 40 may adjust output from device 10 in accordance with how device 10 is being held. For example, if it is determined in step 202 that device 10 is being held on the top and bottom sides (e.g., in a landscape orientation), stereo audio may be output using speakers on the left and right sides of device 10 (i.e., the sides of device 10 not being held or covered by a user's hands).

If desired, other information may be determined using sensors 58 and other actions may be taken based on this information. For example, when a portion or all of the exterior of device 10 is made touch-sensitive using sensors 58, the approximate size of a user's hands may be determined based on the amount of surface area on device 10 covered when the user is holding device 10 in his or her hands. Information about a user's hand size can be used in determining what type of output is appropriate for that user. For example, smaller hands may indicate that a child is using electronic device 10, whereas larger hands may indicate that an adult is using electronic device 10. At step 204, control circuitry 40 may control operation of device 10 based on this information. This may include, for example, adjusting text size in displayed images, adjusting privacy settings, adjusting user interface elements, adjusting display brightness, etc.

The foregoing is merely illustrative of the principles of this invention and various modifications can be made by those skilled in the art without departing from the scope and spirit of the invention. The foregoing embodiments may be implemented individually or in any combination.

What is claimed is:

1. A display having an active area and an inactive area, the display comprising:
a display cover layer;
an opaque masking layer formed on an inner surface of the display cover layer in the inactive area;
an array of pixels that emit light through the display cover layer in the active area; and
a touch sensor having a first portion with touch sensor electrodes in the active area of the display and a second portion with at least one additional touch sensor electrode in the inactive area of the display, wherein the second portion of the touch sensor extends under the opaque masking layer.

2. The display defined in claim 1 wherein the touch sensor electrodes and the at least one additional touch sensor electrode comprise capacitive touch sensor electrodes.

3. The display defined in claim 1 wherein the display cover layer has an opening in the inactive area to accommodate a speaker and wherein the touch sensor detects touches in the inactive area surrounding the speaker.

4. The display defined in claim 1 wherein the opaque masking layer has an opening in the inactive area to accommodate an ambient light sensor and wherein the touch sensor detects touches in the inactive area surrounding the ambient light sensor.

5. The display defined in claim 1 wherein the display cover layer has an opening to accommodate a button and wherein the touch sensor detects touches in the inactive area surrounding the button.

6. The display defined in claim 1 wherein the touch sensor is interposed between the display cover layer and the array of pixels.

7. The display defined in claim 1 wherein the touch sensor electrodes and the at least one additional touch sensor electrode are formed on a common substrate.

8. The display defined in claim 1 wherein the active area has first and second opposing edges, wherein the opaque masking layer has a first portion that shares a border with the active area along the first edge and a second portion that shares a border with the active area along the second edge, and wherein the second portion of the touch sensor extends under both the first and second portions of the opaque masking layer.

9. An electronic device having opposing front and rear surfaces, comprising:
a housing having a peripheral side surface extending between the front and rear surfaces, wherein the housing has a port through which acoustic signals pass;
an audio device mounted in alignment with the port;
a proximity sensor adjacent to the port that detects when the port is obstructed by an external object; and
control circuitry that controls operation of the audio device based on signals from the proximity sensor.

10. The electronic device defined in claim 9 wherein the proximity sensor comprises at least one capacitive touch sensor electrode.

11. The electronic device defined in claim 10 wherein the capacitive touch sensor electrode comprises indium tin oxide.

12. The electronic device defined in claim 9 wherein the port comprises a speaker port and wherein the audio device comprises a speaker.

13. The electronic device defined in claim 9 wherein the port comprises a microphone port and wherein the audio device comprises a microphone.

14. The electronic device defined in claim 13 further comprising:
an additional microphone port formed in the housing;
an additional microphone mounted in alignment with the additional microphone port, wherein the control circuitry controls operation of the additional microphone based on signals from the proximity sensor.

15. The electronic device defined in claim 14 wherein the microphone comprises a first noise cancellation microphone, wherein the additional microphone comprises a second noise cancellation microphone, and wherein the control circuitry gathers noise cancellation microphone signals using the second noise cancellation microphone when the microphone port is obstructed.

16. An electronic device having a display, wherein the display includes an active area and an inactive area, the electronic device comprising:
a display cover layer;
an opaque masking layer formed on an inner surface of the display cover layer in the inactive area, wherein the opaque masking layer has an opening;
an ambient light sensor mounted in alignment with the opening;
an array of pixels that emit light through the display cover layer in the active area;
at least one capacitive touch sensor electrode in the inactive area adjacent to the ambient light sensor; and
control circuitry that controls the ambient light sensor based at least partly on signals from the at least one capacitive touch sensor electrode.

17. The electronic device defined in claim 16 wherein the ambient light sensor is mounted to a flexible printed circuit and wherein the at least one capacitive touch sensor electrode is formed on the flexible printed circuit.

18. The electronic device defined in claim 17 wherein the at least one capacitive touch sensor electrode comprises a ring-shaped capacitive touch sensor electrode that surrounds the ambient light sensor on the flexible printed circuit.

19. The electronic device defined in claim 16 wherein the capacitive touch sensor electrode comprises indium tin oxide.

20. The electronic device defined in claim 16 wherein the opaque masking layer covers the at least one capacitive touch sensor electrode.
